(19) United States
(12) Patent Application Publication
(10) Pub. No.: US 2019/0281810 A1
(43) Pub. Date: Sep. 19, 2019

(54) OUTDOOR INSECT REPELLANT SYSTEM

(71) Applicant: Broan-NuTone LLC, Hartford, WI (US)

(72) Inventors: Richard R. SINUR, West Bend, WI (US); Ryan A. REVERS, Hartland, WI (US)

(21) Appl. No.: 15/921,377

(22) Filed: Mar. 14, 2018

(51) Int. Cl. A01M 29/12

(52) U.S. Cl. CPC A01M 29/12; B05B 7/1686; A01M 2200/012

(57) ABSTRACT

An outdoor repellant system for providing an insect controlled region at a home, restaurant or business. The repellant system includes a plurality of repellant devices, wherein each repellant device includes a fixture, a support member and a stake configured to be inserted into a support surface, such as the ground. The repellant device also includes a device wire that extends through the fixture, the support member and the stake. The device wires are coupled by a connector with an internal adaptor to a main power line that is routed along the support surface and electrically connected by a programmable controller to a primary power source. The fixture includes a number of internal components, including a volatilizing unit that ensures the proper disbursement of repellant through the fixture to provide the insect controlled region.

### TECHNICAL FIELD

The present invention relates generally to an insect repellant system, and more specifically to an outdoor insect repellant system that includes multiple fixtures arranged about an outdoor area, where each fixture disperses a volatized repellant in a localized area to provide a combined insect controlled region.

### BACKGROUND

Numerous outdoor activities are often enjoyed with family and friends in the backyard of a home. Other popular outdoor activities include dining or relaxing around a home or restaurant's deck or patio area. During certain seasons of the year, however, insects and other bugs can become a nuisance to people trying to enjoy the backyard, deck or patio environment. It is not uncommon for people to apply insect repellant in an attempt to fend off insects, such as mosquitos. While the application of insect repellant onto a person's skin is often an effective technique to repel insects, it needs to be re-applied frequently when the person spends extended period of time outdoors. For some people, even a single application of insect repellant can cause skin irritation (e.g., a skin rash), which is exacerbated by repeated application of the repellant over extended period of time. Another common technique to repel insects and bugs from yards, patios or decks involves utilizing combustible repellants such as citronella candles or repellant fuel disposed in torch-like products temporarily driven into the local ground area (e.g., “tiki torches”). While these common repellant techniques can be somewhat effective, they often require frequent monitoring to refill the repellant and may require replacement of the repellant after just a few periods of use.

Another conventional approach to repelling insects includes a battery operated device for dispersing the repellant. These battery operated devices suffer from a number of limitations, including poor repellant range, meaning that these devices do not provide a broad area of coverage to deter and/or repel insects such as mosquitos. In addition, the dry cell batteries for these devices include a limited life span and require frequent replacement during prolonged hours in the backyard. The ongoing replacement of the dry cell batteries is both time consuming and quite costly over the course of an entire season of use of the device. Accordingly, there is a need to overcome certain of these limitations and other drawbacks of the prior art, and to provide new features not heretofore available.

### SUMMARY OF THE INVENTION

According to an aspect of the disclosure, an outdoor repellant system for providing an insect region at an installation site comprises a plurality of repellant devices. Each repellant device includes a fixture, a support member, and a stake configured to be inserted into a support surface, such as the ground, at the installation site, which may be a home, a restaurant, or a business. The repellant device includes a device wire that extends through the fixture, the support member, and the stake. The repellant device further includes an external connector that is electrically coupled to the device wire. A main power line is electrically connected to a primary power source and routed within or along the support surface at the installation site. The main power line extends through a wire adaptor positioned within the connector to electrically connect with the device wire and provide power to the repellant devices. The main power line is electrically connected by a programmable controller to a power source for operation of the repellant devices.

In a connected use position, the support member is coupled to a lower portion of the fixture and the support member is further coupled to the stake. In this position, the fixture is elevated by the support member above the support surface to provide the insect controlled region at the installation site.

Each fixture of the outdoor repellant system comprises a fixture head with at least one outlet opening through which volatized repellant is discharged. The fixture head also has at least one internal latch receptacle. Each fixture also comprises a fixture base with at least one inlet opening through which inlet air is drawn. The fixture base has at least one internal latch that releasably and securely mates with the latch receptacle of the fixture head to releasably secure the fixture base to the fixture head in a connected use position. The fixture further comprises a repellant reservoir removably secured within the fixture by a volatilizing unit that provides for volatilization of repellant from the reservoir. The fixture further includes a release mechanism operably connected to the internal latch of the fixture base. An operator can actuate the release mechanism to disengage the internal latch from the latch receptacle of the fixture head in order to detach the fixture head from the fixture base and displace the fixture head from the connected use position to a disconnected position.

The volatilizing unit comprises the repellant reservoir, a bracket, a heater residing within a cavity of the bracket, and a reservoir coupler extending downward from the bracket. When the fixture is in the connected use position, an upper extent of the repellant reservoir is received by the reservoir coupler to join the repellant reservoir to the bracket. The repellant reservoir includes a wick with an upper portion that extends upward through an upper opening in the repellant reservoir. The upper portion of the wick extends (i) through an aperture in the bracket and (ii) into an aperture in the heater for controlled volatilization of repellant from the reservoir.

Additional features, advantages, and embodiments of the present disclosure may be set forth or apparent from consideration of the following attached detailed description and drawings. Moreover, it is to be understood that both the foregoing summary of the present disclosure and the following detailed description of figures are exemplary and intended to provide further explanation without limiting the scope of the present disclosure as claimed.

### BRIEF DESCRIPTION OF THE DRAWINGS

To understand the present invention, it will now be described by way of example, with reference to the accompanying drawings in which:

FIG. 1A is a perspective view of an exemplary repellant system having six repellant devices installed about an outdoor deck of a home;

FIG. 1B is a perspective view of the repellant system illustrating an operational repellant zone of each device of the system;

FIG. 2 is a perspective view of the repellant system showing the repellant devices electrically coupled to a main power line and a programmable controller;

FIG. 3 is a perspective view of a repellant device of the repellant system installed in the ground G with a stake shown in phantom;

FIG. 4 is an exploded view of a repellant device of the repellant system, showing a fixture, a support pole, and a stake of the repellant device;

FIG. 5 is a cross-sectional view of the fixture and an upper extent of the pole in a connected use position, taken along line 5-5 of FIG. 3;

FIG. 6A is a bottom view of a volatilizing unit of the fixture, showing the heater bracket of the volatilizing unit;

FIG. 6B is a bottom perspective view of the heater bracket;

FIG. 7 is a perspective view of the repellant reservoir coupled to the volatilizing unit of the fixture, including the heater bracket, a heater, and a reservoir coupler;

FIG. 8 is an exploded view of the volatilizing unit of FIG. 7;

FIG. 9 is cross-sectional view of the volatilizing unit taken within line 9-9 of FIG. 5;

FIG. 10 is a cross-sectional view of the volatilizing unit taken along line 10-10 of FIG. 9;

FIG. 11 is a partial exploded view of the repellant device showing the fixture detached from the support pole;

FIG. 12 is a partial exploded view of the repellant device showing a disconnected position wherein the fixture head is detached from the fixture base to provide access to the repellant reservoir;

FIG. 13 is a cross-sectional view taken along line 13-13 of FIG. 3 showing internal components of the fixture and the release buttons in a non-depressed state;

FIG. 14 is a cross-sectional view similar to FIG. 13 illustrating the release buttons of the fixture base in a depressed state due to the application of an inwardly directed disconnection force F;

FIG. 15 is a detailed view taken within line 15-15 of FIG. 14 showing the application of an inwardly directed disconnection force F to enable the fixture head (shown in phantom lines) to be removed and elevated from the fixture base;

FIG. 16 is a sectional view of the stake of the repellant device in a pre-installation position showing a striker cap elevated above the stake and the ground;

FIG. 17 is a sectional view of the stake of FIG. 16 in an installed position into the ground with the striker cap removably joined to the stake;

FIG. 18 is a sectional view of the stake of FIG. 16 in the installed position with the striker cap removed and showing insertion of the support pole into the stake;

FIG. 19 is an exploded view of the repellant device showing the insertion of the support pole into the stake and a device wire that extends through the support pole and an upper extent of the stake;

FIG. 20 is cross-sectional view taken along line 20-20 of FIG. 3 illustrating the repellant device in an installed position in the ground G;

FIG. 21 is a perspective view of a connector of the repellant system in an open, unclamped state and coupled to the device wire;

FIG. 22 is a perspective view of the connector of FIG. 21 showing a wire adapter positioned within the connector and a main power line extending through both the adapter and connector;

FIG. 23 is a perspective view of the wire adapter of the repellant system; and

FIG. 24 is an exploded view of a controller and controller bracket of the repellant system.

In one or more implementations, not all of the depicted components in each figure may be required, and one or more implementations may include additional components not shown in a figure. It should be noted that the features illustrated in the drawings are not necessarily drawn to scale, and features of one embodiment may be employed with other embodiments as the skilled artisan would recognize, even if not explicitly stated herein. Variations in the arrangement and type of the components may be made without departing from the scope of the subject disclosure. Additional components, different components, or fewer components may be used within the scope of the subject disclosure. Moreover, it is noted that like reference numerals represent similar parts throughout the several views of the drawings.

### DETAILED DESCRIPTION OF THE DRAWINGS

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

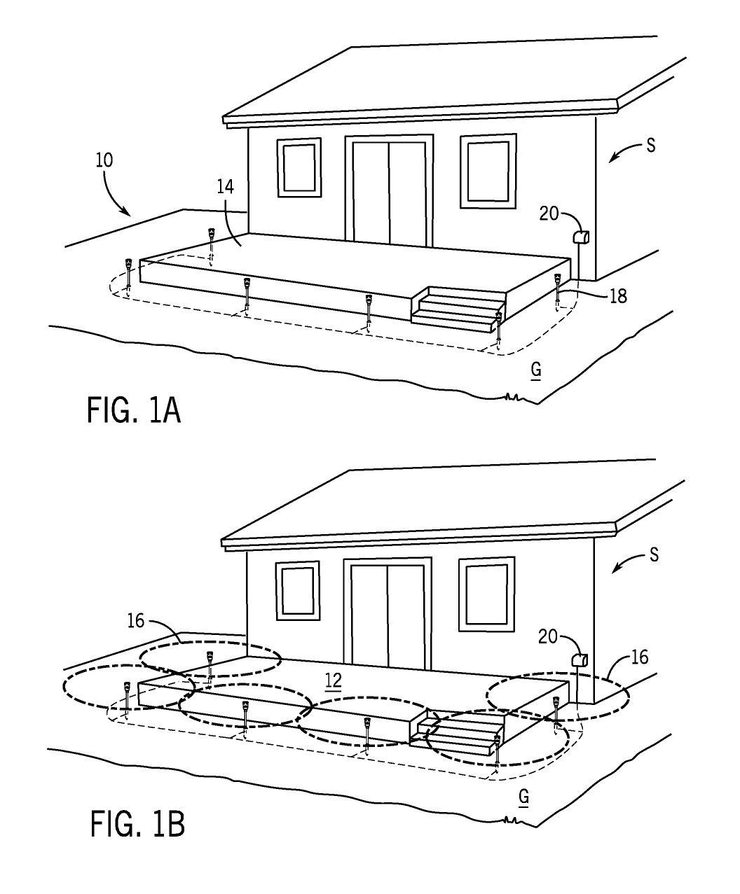

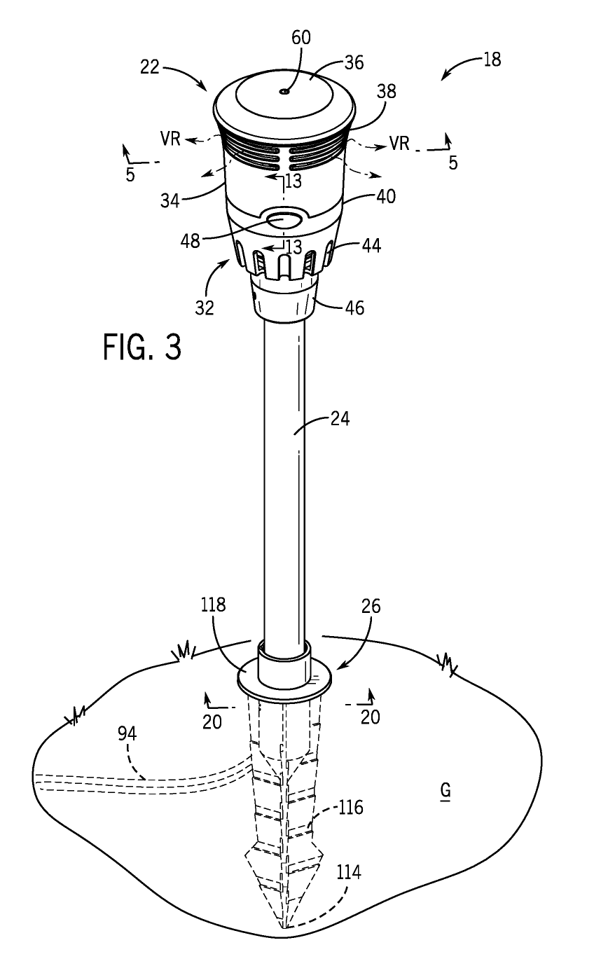

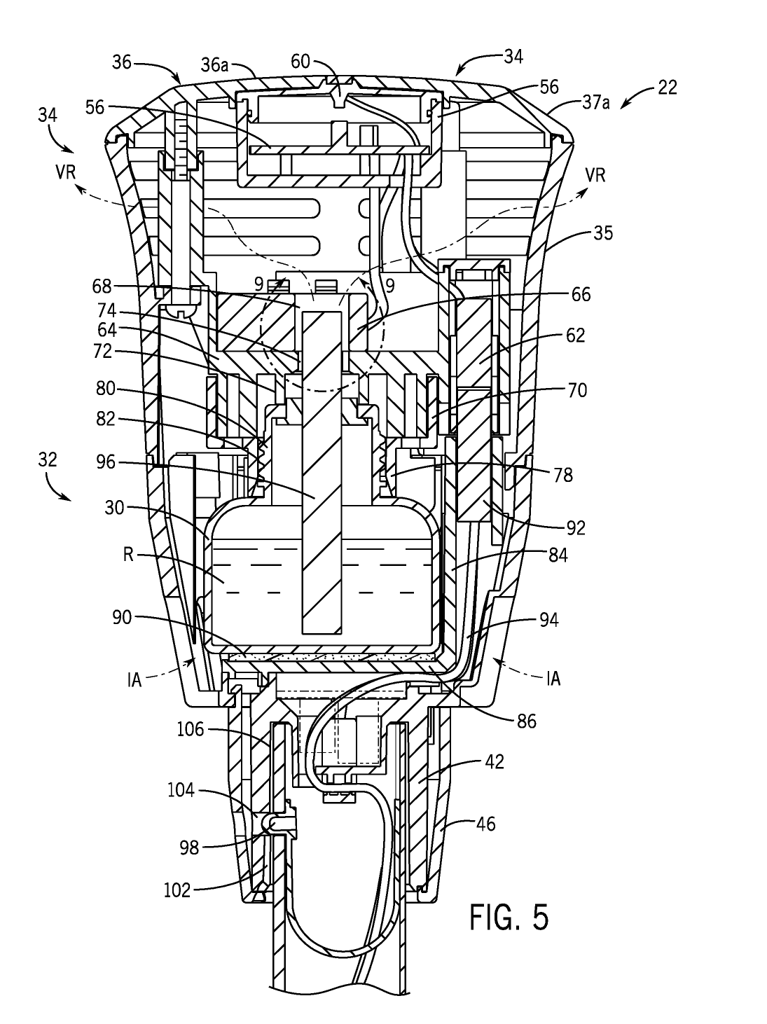

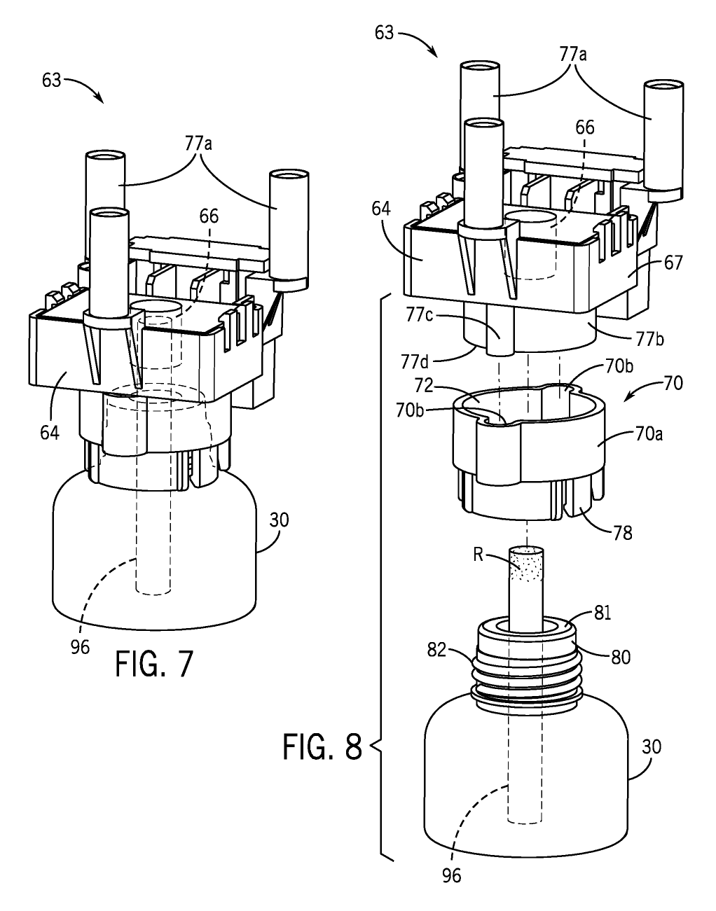

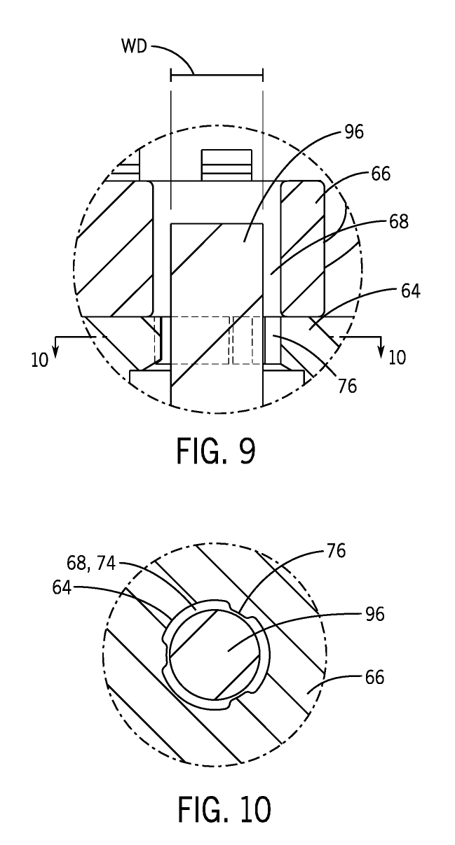

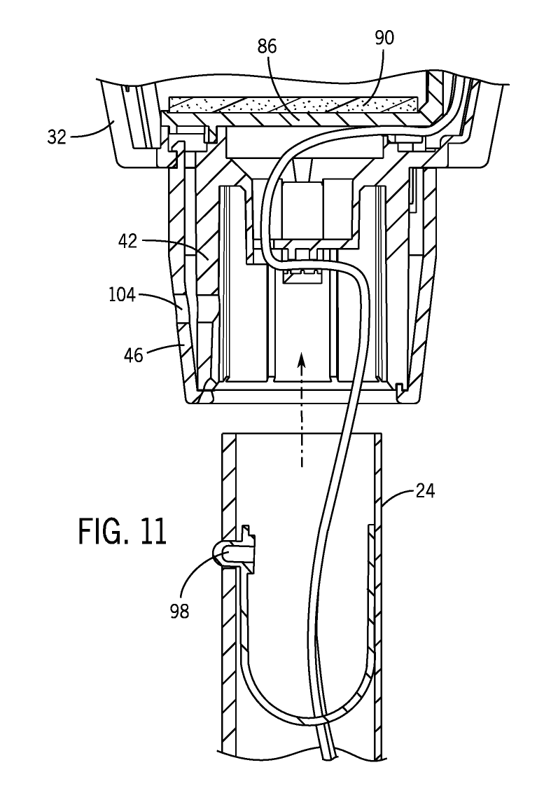

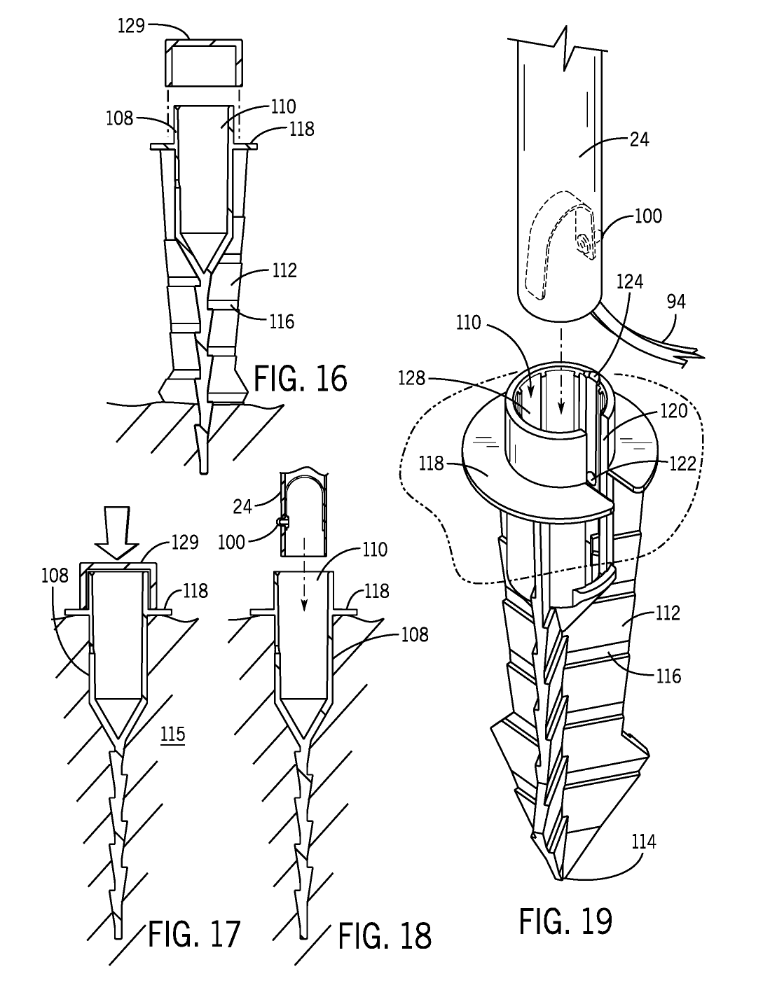

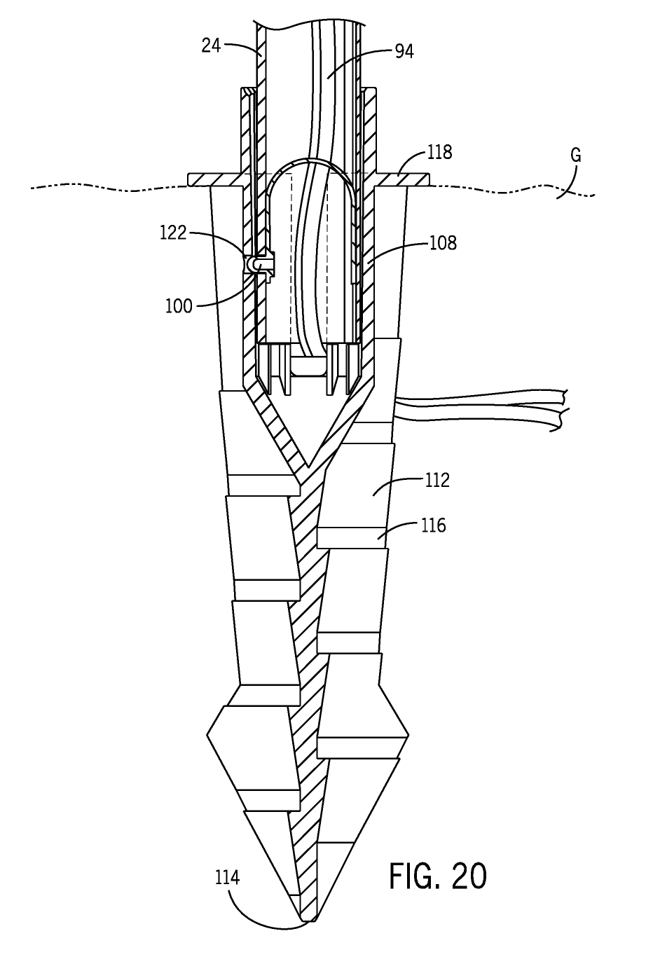

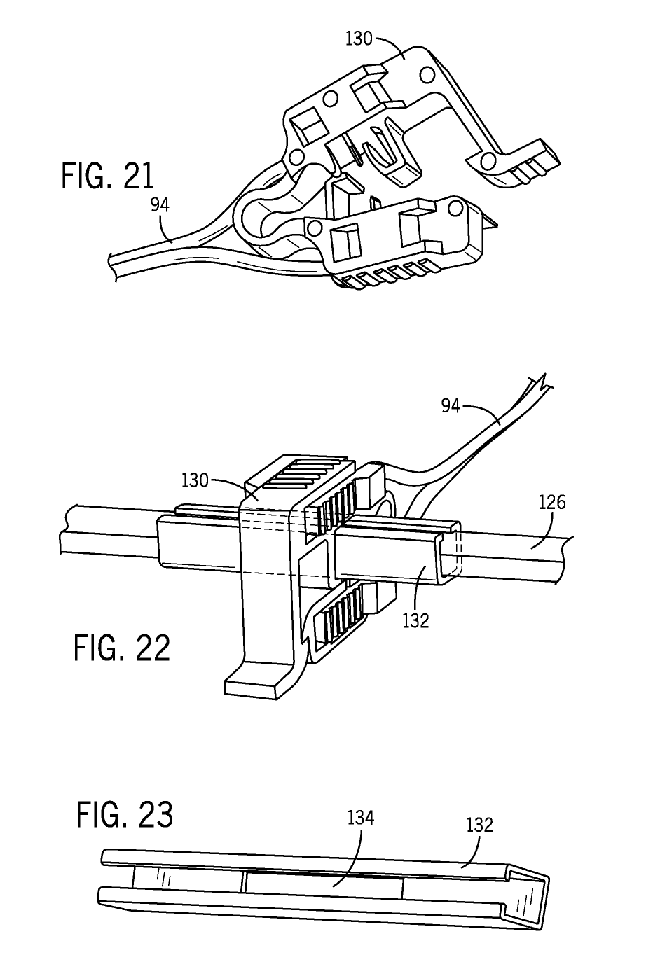

FIGS. 1A, 1B through 24 show an exemplary outdoor insect and bug repellant system 10 constructed in accordance with the present disclosure. The repellant system 10 is designed to discharge a volatized repellant VR (see FIGS. 3 and 5) to provide an insect controlled region 12 for an outdoor area such as, but not limited to, a deck 14, a patio, or other outdoor areas where people gather, relax or enjoy the outdoors. The repellant system 10 includes at least one repellant device 18 that provides a localized, operational repellant zone 16. As shown in FIGS. 1A and 1B, when the repellant system 10 includes a plurality of repellant devices 18 that provide localized, operational repellant zones 16, which can be strategically arranged, tangentially or adjacently overlapping each other, to combine and create the insect controlled region 12. In particular, the repellant system 10 includes a plurality of repellant devices 18 and a controller 20 electrically coupled to the plurality of repellant devices 18 to discharge the volatized repellant VR and provide the repellant zone 16 about the device 18. In another configuration, for example, where operating space is limited and thus the desired insect control region 12 is small, the system 10 includes only single device 18 and the controller 20.

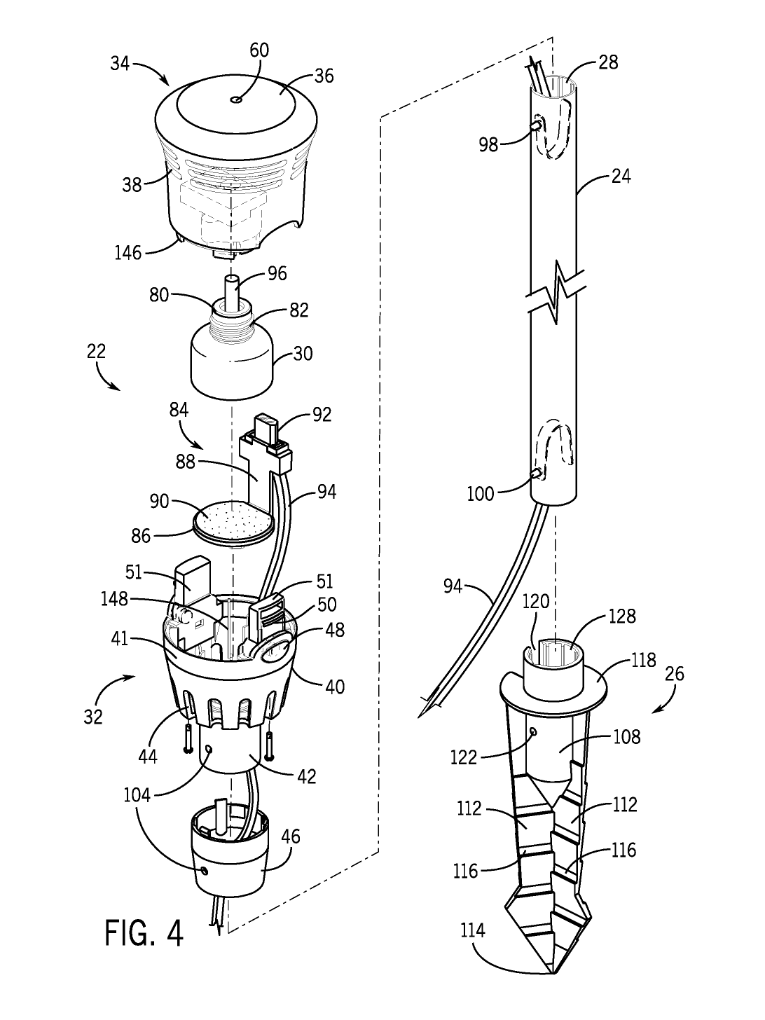

With reference to FIGS. 3 and 4, each repellant device 18 comprises a fixture 22, an elongated support member or pole 24, and a stake 26 configured to be driven into a support surface, such as the ground G. Alternatively, the support member 24 and/or the stake 26 are configured to be secured to an extent of the deck 14, such as a railing. The fixture 22 is removably coupled to an upper end of the support pole 24, where the support pole 24 includes a hollow cylindrical shape defining an internal channel 28 that extends through the pole 24. As discussed below, a lower end of the support pole 24 is removably coupled to the stake 26, for example, inserted into the stake 26. Referring to FIG. 3, a substantial extent of the stake 26 is inserted in the ground G while the device wire or lead 94 is routed through or above the ground G and whereby fixture 22 is elevated a distance consistent with the length of the pole 24 above the ground G to provide the fixture 22 with an elevated discharge position for the volatized repellant VR.

The fixture 22 comprises a fixture base 32 and a fixture head 34, where the head 34 is removably attached to the base 32, as discussed below. The repellant reservoir 30 is removably positioned within the fixture 22 in the connected use position of FIG. 3, and is accessible by the user in the disconnected position when the head 34 is disconnected or detached from the base 32 to attain the disconnected position of FIG. 12. The fixture head 34 has a side wall arrangement 35 that provides the head 34 with a substantially cylindrical configuration. The head 34 also includes a cover 36 with a top wall 36a and a beveled wall 36b extending between the periphery of the top wall 36a and an upper edge of the side wall 35. The fixture head 34 further includes a plurality of outlet openings 38 circumferentially arranged in the side wall 35. Alternatively, the head 34 can be configured with openings 38 formed in the top wall 36, or both the side wall 35 and the cover 36. The fixture base 32 includes a substantially cylindrical body 40 coupled to a collar 42 that extends downward or depends from the body 40. The cylindrical body 40 of the fixture base 32 tapers slightly radially inward towards the collar 42. A plurality of inlet openings 44 are circumferentially arranged in the body 40 of the fixture base 32. In some embodiments, the inlet openings 44 are spaced a distance apart from each other such that they do not overlap while having a major axis that extends axially of the base 32. The inlet openings 44 are configured to permit the entry of inlet air IA (see FIG. 5) into the base 32, which provides a consistent flow of supply air to the fixture 22. The fixture base 32 also includes a lower base cover 46 which receives and shrouds the collar 42. In some embodiments, the lower base cover 46 snaps over and around the collar 42.

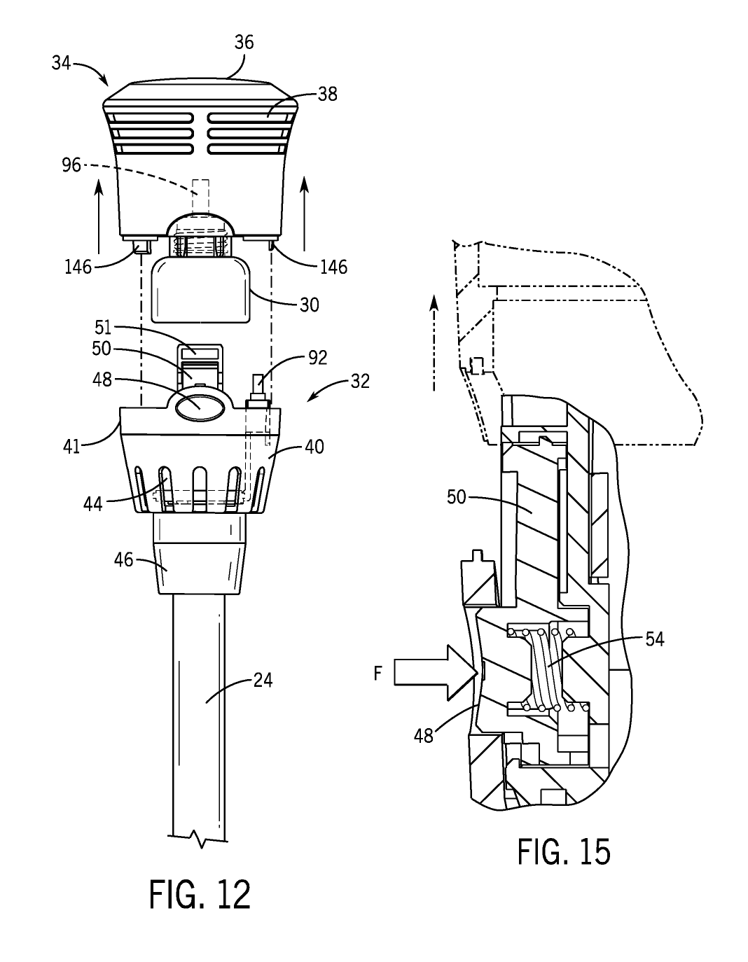

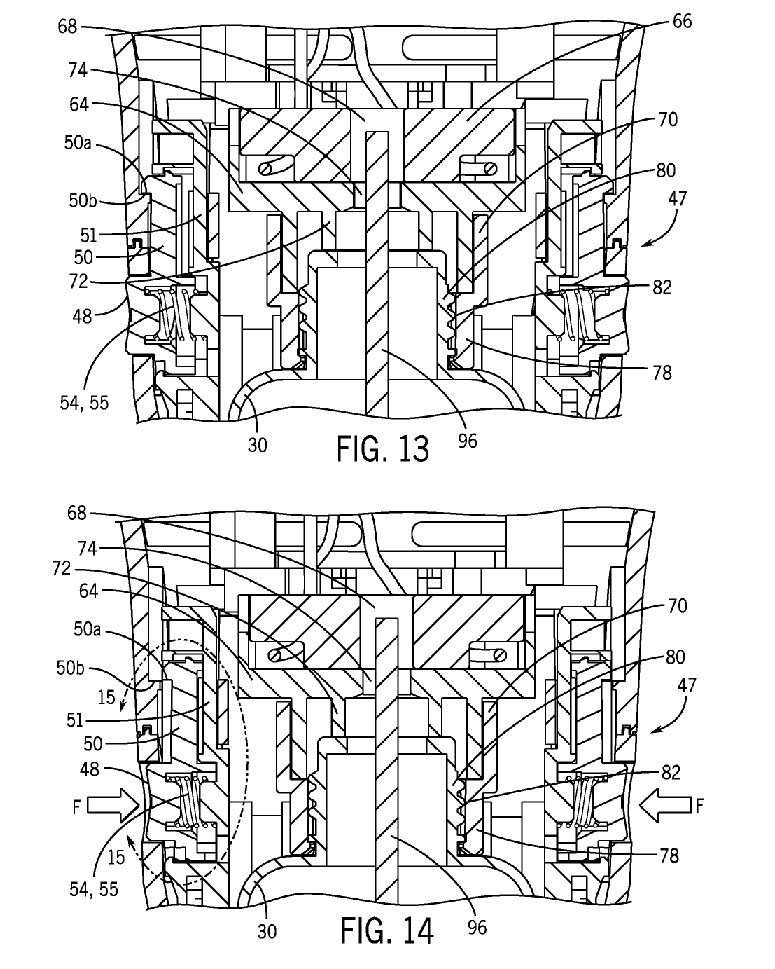

Referring to FIGS. 3-5 and 12-15, the fixture base 32 also includes a pair of opposed release buttons 48 exposed through, and substantially flush with, the side wall 41 of the cylindrical body 40 of the fixture base 32. Each release button 48 is operably coupled to a latch 50 disposed in the interior of the fixture base 32 such that the latches 50 also oppose each other. Each latch 50 extends axially upward toward the fixture head 34 and is configured to releasably and securely mate with a corresponding latch receptacle 52 disposed in the interior of the fixture head 34, as shown in FIGS. 12 and 13. The latch 50 resides in a latch housing 51 that extends upward from the fixture base 32 and into the fixture head 34 when the fixture 22 is in the connected use position (see, e.g., FIG. 3). In some embodiments, the latch receptacle 52 extends from a lower edge of the fixture head 34 towards the cover 36, namely the top wall 36a, of the fixture head 34. The structural and functional interaction between the latch 50 and the latch receptacle 52 provides for removable attachment of the fixture head 34 to the fixture base 32, which is effectuated by a user depressing a release mechanism 47 including the release buttons 48, as discussed below. Each opposed latch 50 is pre-loaded with a resilient member 54 of the release mechanism 47 such as, but not limited to, a biasing member, such as a spring 55. In the connected use position, as shown in FIGS. 3, 5 and 13, the head 34 is coupled to the base 32 and the opposed pair of release buttons 48 are in the non-depressed state. In the connected use position, each internal latch 50 includes a projection 50a that engages with a securing element 50b formed in the latch receptacle 52 to ensure secure coupling of the fixture head 34 to the fixture base 32.

To move from the connected use position to a disconnected or released position, as shown in FIG. 12, which allows the user to gain access to the internal components of the fixture 22, including to allow removal and replacement of a spent repellant reservoir 30, the user simultaneously applies an inwardly directed disconnection force F to depress each release button 48, as shown in FIGS. 14 and 15. This disconnection force F releases (e.g., unseat) each opposed latch 50 from its corresponding latch receptacle 52 so that the fixture head 34 can be removed and elevated from the fixture base 32 to reach the disconnected position (see FIG. 12). When the user or operator applies provides a sufficient disconnection force to both release buttons 48 of the release mechanism 47, the projection 50a disengages from the securing element 50b whereby the user can apply an upwardly directed force on the head 34 to disengage and elevate it away from the base 32. This disengagement and elevation force is oriented parallel to, or substantially parallel to, a longitudinal axis of the fixture 22. In the embodiment shown in FIGS. 3-19, the longitudinal axis of the fixture 22 is aligned with the axis of the support pole 24.

A printed circuit board (PCB) bracket 56 is mounted within the fixture head 34, preferably to the cover 36 of the fixture head 34. The PCB bracket 56 supports a printed circuit board (PCB) 58 that controls operation of the heater element 66. A light emitting diode (LED) 60 is electrically coupled to the fixture PCB 58 and is partially disposed through the head cover 36 in such a manner that the LED 60 is visible exteriorly of the fixture head 34. The LED 60 is configured to illuminate when the repellant device 18 is operational, and it can illuminate other colors or patterns (e.g. flashing light pattern) when the device is not operational (i.e. in the “off” state) or is malfunctioning. In some embodiments, the fixture PCB 58 includes a rectifier (not shown) for converting alternating current (AC) to direct current (DC). A head electrical connector 62 mates with a base electrical connector 92 in the connected use position, and the connector 62 is also electrically coupled via a lead to the fixture PCB 58 to supply power to the PCB 58.

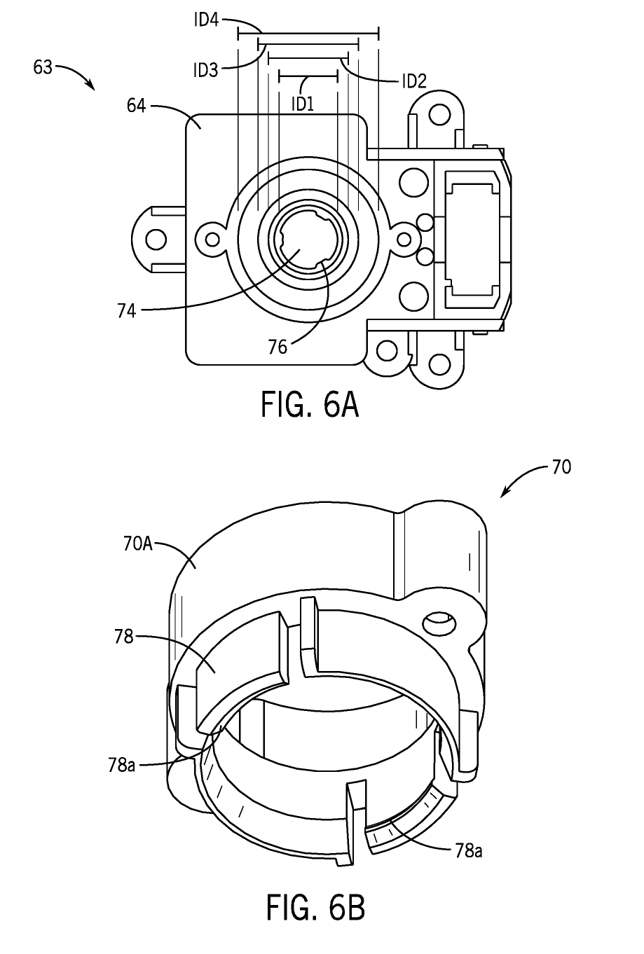

FIGS. 6-8 show the repellant reservoir 30 and a volatizing unit 63 which comprises a heater bracket 64, a heater 66 residing within a receptacle 64a formed by a sidewall arrangement of the bracket 64, and a reservoir coupler 70. The volatizing unit 63 converts the liquid repellant R in the reservoir 30 to a gaseous state by the application of heat via the heater 66 to repellant R that is carried by the wick 96 and brought in close proximity to, but not in contact with, the heater 66. The heater bracket 64 is mounted within the fixture head 34 and is arranged below the PCB bracket 56 to form a cavity within the fixture head 34. The heater 66 is electrically coupled to the fixture PCB 58 and includes a heater aperture 68 disposed there through, wherein this aperture 68 also receives an extent of the wick 96 that is saturated with repellant from the reservoir 30. In addition to the heater 66, the heater bracket 64 also supports the head electrical connector 62. Further, the heater bracket 64 includes a guide aperture 74 disposed there through that is aligned with the heater aperture 68 and that is configured to receive an extent of the wick 96. A plurality of guide ribs 76 are disposed on the inner diameter, or inner wall, of the guide aperture 74 to ensure proper positioning of the wick 96 with respect to the heater 66. A plurality of elongated support members 75 extend upward from the heater bracket 64 to facilitate proper positioning of the heater bracket 64 within the fixture head 34. A depending flange 77b of the heater bracket 64 extends downward or depends from the heater bracket 64. The heater bracket 64 includes opposed bosses 77c arranged on the exterior of the depending flange 77b of the heater bracket 64.

While the heater 66 is disposed on the upper side of the heater bracket 64, a reservoir coupler 70 is coupled to the lower side of the heater bracket 64. The reservoir coupler 70 includes a body 70a, having a substantially cylindrical configuration, and opposed recesses 70b formed in the body 70a for correspondingly receiving the opposed bosses 77c of the heater bracket 64. For example, when the reservoir coupler 70 is coupled to the heater bracket 64, the opposed recesses 70b receive the opposed bosses 77c while the body 70a receives the depending flange 77b of the heater bracket 64 in such a manner that the depending flange 77b resides within the reservoir coupler 70 and does not contact the cylindrical body 70a, but is offset radially coaxially from the body 70a. The reservoir coupler 70 includes a central aperture 72 formed through the body 70a. The reservoir coupler 70 also includes at least one retention tab 78 extending downward or depending from the body 70a and being positioned between depending fixed segments 79. The retention tabs 78 are configured for receiving and removably securing or joining a neck 80, or upper extent, of the reservoir 30 to the heater bracket 64. The retention tabs 78 can formed to flex radially outward and elastically deform when they receive and engage the neck 80 of the reservoir 30. In some embodiments, the neck 80 includes a plurality of threads 82 disposed around the outer diameter of the neck 80 so that internal ridges 78a of the plurality of retention tabs 78 can engage and grip the plurality of threads 82 when the reservoir 30 is inserted into the reservoir coupler 70.

When the fixture 22 is assembled in the connected use position, the heater aperture 68 of the heater 66, the guide aperture 74 of the heater bracket 64, a flange aperture 77d of the depending flange 77b, and the neck-receiving aperture 72 are all coaxially aligned. In particular, the guide aperture 74 includes an inner diameter ID1 that is less than an inner diameter ID2 of the flange aperture 77d, which is, in turn, less than an inner diameter ID3 of the body 70a. In this arrangement, the plurality of retention tabs 78 collectively includes an inner diameter ID4 that is substantially similar to the inner diameter ID3 of the body 70a when the reservoir 30 is removed therefrom. When the neck 80 of the reservoir 30 is received by the retention tabs 78, however, the inner diameter ID4 expands slightly to secure the neck 80 in a press-fit arrangement such that an uppermost lip 81 of the neck 80 sits within the inner diameter ID2 of the flange aperture 77d and sits against the heater bracket 64 in this location.

As shown in FIGS. 5 and 9-11, the fixture 22 further includes a connector bracket 84 disposed in the fixture base 32. In some embodiments, the connector bracket 84 is mounted in the fixture base 32. The connector bracket 84 includes a reservoir support 86 and a connector holder 88 extending substantially orthogonally from the reservoir support 86. The reservoir support 86 is configured to support the reservoir 30. A compressible resilient member 90, such as an elastically deformable pad, is disposed between the reservoir 30 and the reservoir support 86 to further support the reservoir 30. The compressible resilient member 90 is configured to, in the connected use position, apply an axially directed upward force on the reservoir 30 to displace the reservoir 30 into the reservoir coupler 70. The upwardly directed force provided by the resilient member 90 helps to ensure proper positioning of the reservoir wick 96 through the heater bracket 64 and into the heater 66. Thus, in the connected use position, the resilient member 90 displaces the reservoir 30 axially upward so that the reservoir neck 80 is properly secured by the retention tabs 78. In this arrangement, the uppermost lip 81 of the neck 80 is surrounded by the depending flange 77b of the heater bracket 64 and abuts against the heater bracket 64 within the depending flange 77b. Further, the wick 96 is disposed with the guide aperture 74 such that the plurality of guide ribs 76 constrict a diameter WD of the wick 96 to ensure that the wick 96 is disposed within the heater aperture 68 without making contact with the heater 66. By preventing the wick 96 from making contact with the heater 66, the plurality of guide ribs 76 ensures proper positioning of the wick 96 with respect to the heater 66 so that the insect repellant R is volatized properly during operation of the device 20. The connector holder 88 secures and supports a base electrical connector 92, which is configured to matingly and electrically couple with the head electrical connector 62. The base electrical connector 92 is also electrically coupled to the device wire 94 that extends through the support pole 24 and an extent of the stake 26.

The reservoir 30 is configured to contain any insect repellant R capable of being vaporized and includes a wick 96 partially disposed within the reservoir 30. For example, in some embodiments, the insect repellant fluid R comprises one or more of permethrin, bifenthrin, prallethrin, allethrin, esbiothrin, tretramethrin, d-tetramethrin, phenothrin, metofluthrin, metofluthrin and petroleum distillate, profluthrin, dimefluthrin, trnasfluthrin, imiprothrin, empenthrin, dichlorvos, tetfluthrin, phenothrin, cypermethrin, etofenprox, pacardin, n,n-diethy-m-toluamide, N,N-diethyl-3methylbenzamide, any pyrethroid-containing compound, an allyl sulfide, garlic oil, garlic paste, garlic emulsion, and any other well-known insect repellant substances. In some embodiments, the wick 96, for example, comprises any substantially absorbent material, such as, but not limited to, felt, cotton, cloth, pulp, paper, a porous resin (polypropylene foam, urethane foam, etc.), un-woven fabric, porous ceramics, synthetic fiber (nylon, polyester, polypropylene, etc.), natural fibers (wool, silk, cotton, hemp, etc.), inorganic substances, or any combination thereof. The wick 96 extends at least the length of the reservoir 30 such that a substantial portion of the wick 96 is disposed within the reservoir 30 while portions of the wick 96 also protrude outwardly from the neck 80. In such a manner, the wick 96 functions to absorb the insect repellant R from within the reservoir 30 and transfer the insect repellant R outside of the reservoir 30 (e.g., via capillary action, diffusion, etc.) such that the heater 66 heats and volatizes the insect repellant R carried by the wick 96 into volatized repellant VR.

Referring back to FIGS. 4, 5 and 11, the support member 24 includes a fixture detent 98 and a stake detent 100 both disposed within the internal channel 28. In some embodiments, the fixture detent 98 and the stake detent 100 are spring buckles. The fixture detent 98 is configured to align with and follow along a fixture detent lead groove 102 disposed in the interior of the collar 42 of the fixture base 32. Accordingly, when inserting the support member 24 into the collar 42 of the fixture base, after having positioned the device wire 94 through the internal channel 28, the fixture detent 98 is depressed and aligned with the fixture detent lead groove 102 such that the fixture detent 98 follows along the fixture detent lead groove 102, as the support member 24 is being inserted, until the fixture detent 98 reaches a fixture detent seat 104 disposed through the collar 42 at which point the fixture detent 98 protrudes through and locks into the fixture detent seat 104. As such, the support member 24 is removably secured to the fixture base 32 of the fixture 22. In some embodiments, a plurality of collar ribs 106 are disposed in the interior of the collar 42 for resiliently receiving the support member 24 and exerting radial pressure against the support member 24 to ensure a snug fit of the support member 24 within the collar 42.

Referring to FIGS. 4 and 16-20, the stake 26 includes a stake body 108. The stake body 108 includes an internal channel 110 disposed therethrough for removably receiving the support member 24. An arrangement of splines 112 outwardly and downwardly extends from the stake body 108 and terminates at a pointed tip 114. As a result, the lower portion of the stake 26 has an arrow-shaped configuration which assists with insertion of the stake 26 into the ground G or another support surface (e.g., grass, mulch, dirt). A plurality of angular ramps 116 are disposed on the outer surfaces of each wall of the spline 112, where each ramp 116 is equally spaced apart axially from each other along the outer surface and forms an acute angle with the outer surface of the wall to assist with insertion of the stake 26 into the ground G while preventing the stake 26 from being easily pulled up and removed from the ground G. In this manner, the plurality of ramps 116 provides an anchor-like feature for the stake 26.

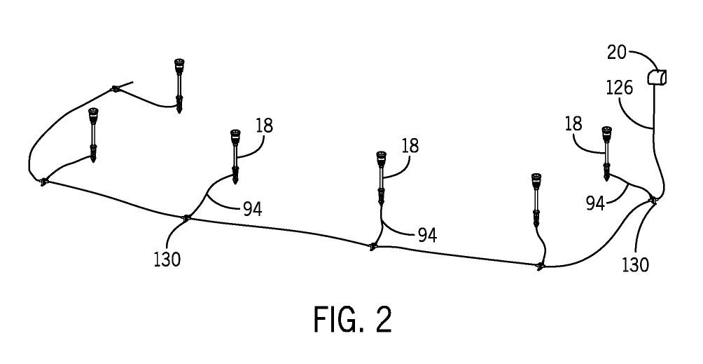

As best shown in FIGS. 4,19 and 20, a flange 118 extends radially outward from an upper region of the stake body 108. The splines 112 extend, preferably integrally, from the flange 118 The stake 26 also includes a notch 120 formed in an upper region of the stake body 108 and through the flange 118 to provide a clearance for receiving an extent of the device wire 94. The stake body 108 also includes a detent seat 122 disposed therethrough for receiving the stake detent 100 associated with and positioned proximate the lower end of the support member 24. The body 108 includes a detent lead groove 124 disposed in the interior of the body 108 along the channel 110. During insertion and coupling of the support member 24 to the stake 26 with the device wire 94 received in the notch 120, the stake detent 100 is configured to align with and follow along the detent lead groove 124 until the stake detent 100 reaches the corresponding detent seat 122 at which point the stake detent 100 protrudes into and locks into the detent seat 122. As such, the support member 24 is fixedly, yet removably, secured to the stake 26 while the device wire 94 is routed through the support member 24 and stake 26 while exiting via the notch 120. The extent of the device wire 94 that extends beyond the stake 26 is electrically and mechanically connected to the main power line or wire 126 (shown in FIG. 2), as described further below. Referring to FIGS. 4 and 19, the stake 26 can include internal ribs 128 disposed in the channel 110 for resiliently receiving the support member 24 and exerting radial pressure against the support member 24 to ensure a snug fit of the support member 24 within the stake body 108. Additionally, a striker cap 129 is removably joined to the stake 26 and is configured for placement over the stake body 108 to engage the stake skirt 118. The striker cap 129 provides a user with a surface to strike during installation of the stake 26 into the ground G. The striker cap 129 can then be discarded after installation of the stake 26.

With reference to FIGS. 2 and 21-23, a connector 130 is configured to electrically couple the device wire 94 of each repellant device 18 to the main line 126 connected to a power source by the programmable controller 20. The connector 130 includes a wire adapter 132 which is attached to a desired location of the main wire 126 that is determined by the user or installer of the system 10. The wire adapter 132 includes an opening 134 disposed therethrough such that portions of the main wire 126 are exposed through the opening 134 when the wire adapter 132 is attached to the main wire 126. The wire adapter 132 is configured to properly position and secure the device wire 94 within in the connector 130 and to allow for mechanical and electrical connection of the device wire 94 to the main line 126. For example, the device wire 94 is coupled to the connector 130 by splitting the positive and negative leads, as shown in FIG. 21. With the connector 130 in an open, un-clamped state, a predetermined segment of the main line 126, with the wire adapter 132 attached thereto, is positioned within a receptacle 131 the connector 130 such that the adapter opening 134 is arranged within the receptacle 131. With the main wire 126 and the wire adapter 132 positioned in the receptacle 131, the connector 130 is moved into the closed, clamped state such that prongs 133 of the connector 130 pierce the main wire 126 through the opening 134 to electrically couple the device wire 94 and the main line 126. Because the connector 130 accepts the combined adapter 132 and main line 126, a higher American wire gauge (AWG) main line 126 with a smaller diameter can be used to electrically and mechanically connect with the device wire 94 and provide power to the repellent device 18. In this manner, the adapter 132 effectively increases the interface area between the connector 130 and the main line 126 for mechanical and electrical connection of these components. It is generally understood that higher gauge (AWG) lines, with smaller wire diameters, are less costly than lower gauge (AWG) lines, with larger wire diameters. Thus, the adapter 132 allows for the use of a standard sized connector 130 and a higher gauge main line 126, which reduces the cost of the system 10. If the adapter 132 is omitted and the standard sized connector 130 is maintained, a lower gauge main line 126 (with a greater diameter) would be required to mechanically and electrically couple with the device wire 94, which would decrease the economic efficiency of the inventive system 10.

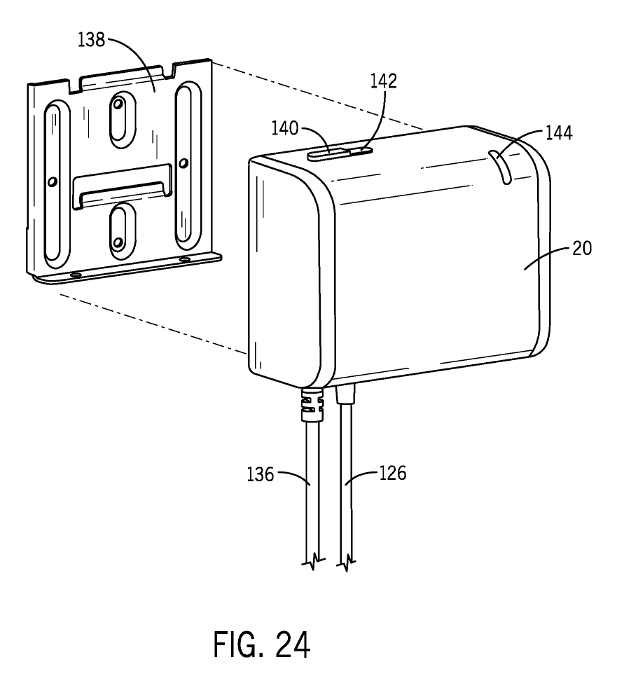

Referring to FIGS. 1A and 24, the main wire 126 is also electrically coupled to the programmable controller 20, which can be affixed to a structure S, such as a house, building or restaurant, near the installation site of the system 10 and the resulting insect control region 12. The controller 20 is electrically coupled to a primary power source (not shown) via a power cord 136. Alternatively, the power cord 136 is omitted and the controller 20 is hard-wired to the primary power source, which can be a 120 VAC that also provides power to the structure S. The controller 20 can be mounted to a structure via a controller bracket 138. The controller bracket 138 can be mounted to the structure with at least one conventional fastener such as screws or bolts. The controller 20 includes an ON/OFF button 140, a reset button 142, and a status indicator 144. In some embodiments, the status indicator 144 is a status light emitting diode (LED). The ON/OFF button 140 is configured to control the turning on and off of the plurality of repellant devices 18 and to illuminate the status indicator 144 to display solid green when in the ON state. In some embodiments, the ON/OFF button 140 is pressed for a short duration to enter the ON state and is pressed for a longer duration to enter the OFF state. Moreover, the controller is configured to also illuminate the LED 60 of each fixture head 34 when in the ON state. The reset button 142 is configured to set a timer for a predetermined time duration when the reset button 142 is pressed for a short duration. The status indicator 144 is configured to, responsive to the reset button 142 being pressed for a short duration, flash green quickly 2-times to indicate the timer is set at the predetermined time duration. In some embodiments, the predetermined time duration is 4 hours, but other durations such as 1 hour, 2 hours, 3 hours, 5 hours, etc. are certainly possible. The status indicator 144 is also configured to display faded green on and off slowly to indicate a full level timer of 195 hours and will continue this illumination pattern until the reset button 142 is pressed and held for 5 seconds, at which point the timer is reset and the status indicator 144 will fade green 5-times and then turn off.

As mentioned above, to allow a user to remove and replace a spent repellant reservoir 30, the fixture head 34 is removed from the fixture base 32 in a unique two-step process: (i) a sufficient inwardly directed force F is applied to each of the opposed pair of release buttons 48 so they can be depressed to release each opposed latch 50 from its corresponding latch receptacle 52, whereupon (ii) the operator (or user) grasps and lifts the fixture head 34 vertically such that the head 34 is removed (e.g., pulled away) from the fixture base 32. While this two-step removal process of depressing the opposed pair of release buttons 48 simultaneously with one hand while lifting the fixture head 34 away with the other hand is convenient, it does not require any special tools to gain access to the reservoir 30, it also functions as a childproof feature to prevent children from gaining unattended access to a spent reservoir 30. With the fixture head 34 removed from the fixture base 32, the reservoir 30 can be removed from the fixture head 34 by pulling the reservoir 30 axially downward from the heater bracket 64 to release the neck 80 from the retention tabs 78 of the reservoir coupler 70. In some embodiments, the reservoir 30 is refillable such that a user can refill the reservoir 30 when depleted of insect repellant R or top-off the reservoir 30 after partial use. In other embodiments, the reservoir 30 is non-refillable such that a user can discard the reservoir 30 when it is depleted and replace it with a new reservoir 30.

To insert or replace the reservoir 30 into the fixture head 34, the user aligns the neck 80 and the wick 96 protruding from the neck 80 with the neck-receiving aperture 72 of the reservoir coupler 70 and pushes axially into the fixture head 34 until the retention tabs 78 receive and secure the neck 80 into place. In particular, as the reservoir 30 is removably received by the retention tabs 78, the plurality of guide ribs 76 disposed along the inner diameter of the guide aperture 74 receive the wick 96 to ensure proper positioning of the wick 96 within the heater aperture 68. Specifically, the plurality of guide ribs 76 centrally locate the wick 96 within the heater aperture 68 ensuring that the wick 96 does not make contact with the heater 66 to thereby establish proper volatilization or vaporization during operation.

With the reservoir 30 removably secured to the fixture head 34, the user can reattach the fixture head 34 back to the fixture base 32 by aligning the head electrical connector 62 of the fixture head 34 with the base electrical connector 92 of the fixture base 32 while inserting the reservoir 30 into the fixture base 32 until each opposed latch 50 securely mates with its latch receptacle 52 such that the head electrical connector 62 and the base electrical connector 92 are matingly and electrically coupled. In this manner, the reservoir 30 is supported on reservoir support 86 such that the resilient member 90 disposed there between forces the reservoir 30 axially upward to further ensure proper positioning of the wick 96 within the heater aperture 68 and with respect to the heater 66. Moreover, while the head electrical connector 62 and the base electrical connector 92 are required to align to ensure that the fixture head 34 is properly removably attached to the fixture base 32, a plurality of keying tabs 146 asymmetrically protruding and extending downward from a lower edge of the interior of the fixture head 34 is also provided to ensure proper alignment and removable attachment of the fixture head 34 to the fixture base 32. In particular, in the connected use position, the plurality of keying tabs 146 is matingly received by (e.g., matingly inserted into) a corresponding plurality of keying grooves 148 formed in an upper edge of the interior of the fixture base 32. Because the plurality of keying tabs 146 is disposed asymmetrically, the plurality of keying tabs 146 can only mate with the corresponding plurality of keying grooves 148 in this one orientation such that the fixture head 34 and the fixture base 32 cannot be properly attached in any other orientation.

During operation of the system 10, the heater 66 provides thermal energy to volatize the insect repellant R in the reservoir 30 via the wick 96. As the insect repellant R volatizes, further volumes of the repellant R is drawn upward through the wick 96 so that volatized repellant VR is substantially continuously released through the plurality of outlets 38 and to form the external insect controlled region 12, as illustrated by the arrows in FIG. 3. In particular, ambient air is drawn into the fixture base 32 via the plurality of inlets 44, as shown in FIG. 5, to circulate upward through the fixture head 34 to mix with the volatized repellant VR and flow outward to the environment via the plurality of outlets 38. Accordingly, the volatized repellant VR circulates and disperses in the environment to create the operational repellant zone 16 around the repellant device 18. In some embodiments, the operational repellant zone 16 is a zone with a 12 foot diameter.

As can be seen from the above description, the outdoor repellant system 10 can be utilized to create the insect controlled region 12 around the deck 14. For example, a stake 26 corresponding to each repellant device 18 can be strategically installed (e.g., driven) into the ground G around the deck 14 to create a predetermined insect controlled region 12 such that the operational repellant zone 16 of each device 18 is either tangent to each other or slightly overlapped. In particular, the striker cap 129 can be placed over the stake body 108 and in contact with the stake skirt 118 so that a user can hit the striker cap 129 with a hammer to install the stake 26 into the ground G without damaging the stake 26. The striker cap 129 can be removed after installation of the stake 26 into the ground G. The main wire 126 can be laid along the ground G in a path to substantially mimic the path of the stakes.

Before attaching the support member 24 to the stake 26, the device wire 94 is routed from the fixture base 32 through the internal channel 28 so that the support member 24 can be attached to the fixture base 32. In particular, the fixture detent 98 is aligned with the fixture detent lead groove 102 and the support member 24 is inserted into the fixture base 32 until the fixture detent 98 locks into the fixture detent seat 104. With the support member 24 attached to the fixture 22 and the device wire 94 extending out of the support member 24 proximate the stake detent 100, the device wire 94 is placed in the notch 120 of the stake body 108 and the stake detent 100 is aligned with the stake detent lead groove 124 so that the support member 24 is inserted into the stake channel 110 until the stake detent 100 is locked into the stake detent seat 122 with the device wire 94 partially exposed through the notch 120.

In this manner, the device wire 94 can be electrically coupled to the main wire 126 by inserting the device wire 94 into the open, unclamped connector 130 along with the main wire 126 and the wire adapter 132 attached thereto. With the device wire 94 and the main wire 126, attached to the wire adapter 132, properly positioned in the connector 130, the connector 130 is then clamped to electrically couple the device wire 94 to the main wire 126. This process can be done for each repellant device 18. Although the device wire 94 of each repellant device 18 and the main wire 126 are disposed either in or above the ground G, because of the notch 120 in the stake body 108 the device wire 94 can optionally be buried underground along with the main wire 126. Then main wire 126 is electrically and mechanically coupled to the controller 20, which itself is coupled to the primary power source at the installation site. When the controller 20 is turned ON (e.g., via the ON/OFF button 140, remotely with a remote control device in wireless communication with the controller, such as, but not limited to a computer, a mobile phone, tablet, or other personal hand held device, automatically, or some other trigger, etc.), the heater 66 of each repellant device 18 volatizes the insect repellant R such that the volatized repellant VR circulates to the environment via the plurality of outlets 38 to create the operational repellant zone 16 and, more broadly, the insect controlled region 12.

While the present disclosure has been described in terms of exemplary embodiments, those skilled in the art will recognize that the present disclosure can be practiced with modifications in the spirit and scope of the appended claims. Further, a person of ordinary skill in the art would appreciate the features of the individual embodiments, and the possible combinations and variations of the components. A person of ordinary skill in the art would further appreciate that any of the examples could be provided in any combination with the other examples disclosed herein. Additionally, the terms “first,” “second,” “third,” etc. as may be used herein are intended for illustrative purposes only and do not limit the embodiments in any way. The term “plurality” as used herein indicates any number greater than one, either disjunctively or conjunctively, as necessary, up to an infinite number. The word “including” as used herein is utilized in an open-ended manner.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

What is claimed is:

1. An outdoor repellant system for providing an insect controlled region at an installation site, the outdoor repellant system comprising:
a plurality of repellant devices, wherein each repellant device includes a fixture, a support member and a stake configured to be inserted into a support surface at the installation site, the repellant device including a device wire that extends through the fixture, the support member and the stake, the repellant device further including a connector that is electrically connected to the device wire; and,
a main power line electrically connected to a primary power source and routed within or along the support surface at the installation site, wherein the main power line extends through a wire adaptor positioned within the connector to electrically connect with the device wire and provide power to the repellant devices.

2. The outdoor repellant system of claim 1, wherein the support member is coupled to a lower portion of the fixture and the support member is further coupled to the stake to provide a connected use position for each repellant device,
wherein in the connected use position, the fixture is elevated by the support member above the support surface to provide the insect controlled region at the installation site.

3. The outdoor repellant system of claim 1, wherein the main power line is electrically connected by a programmable controller to a power source for operation of the repellant devices in a connected use position.

4. The outdoor repellant system of claim 1, wherein each fixture comprises:
a fixture head with at least one outlet opening through which volatized repellant is discharged, the fixture head having at least one internal latch receptacle;
a fixture base with at least one inlet opening through which inlet air is drawn, the fixture base having at least one internal latch that releasably and securely mates with the latch receptacle of the fixture head to releasably secure the fixture base to the fixture head in a connected use position; and,
a repellant reservoir removably secured within the fixture by a volatilizing unit that provides for volatilization of repellant from the reservoir.

5. The outdoor repellant system of claim 4, wherein the fixture includes a release mechanism operably connected to the internal latch of the fixture base;
wherein an operator actuates the release mechanism to disengage the internal latch from the latch receptacle of the fixture head in order to detach the fixture head from the fixture base and displace the fixture head from the connected use position to a disconnected position.

6. The outdoor repellant system of claim 5, wherein the release mechanism comprises a depressible button and a biasing member, the depressible button being accessible through an opening formed in the fixture base.

7. The outdoor repellant system of claim 6, wherein the operator applies an inwardly directed disconnection force to the depressible button in order to disengage the internal latch from the latch receptacle and move the fixture from the connected use position to the disconnected position.

8. The outdoor repellant system of claim 4, wherein the internal latch resides within a latch housing that extends upward from the fixture base into the fixture head when the fixture is in the connected use position.

9. The outdoor repellant system of claim 8, wherein the internal latch includes a projection that engages with a securing element formed in the latch receptacle when the fixture is in the connected use position.

10. The outdoor repellant system of claim 4, wherein the latch receptacle extends from a lower edge of the fixture head towards a top wall of the fixture head.

11. The outdoor repellant system of claim 4, wherein the fixture head includes at least one keying tab extending downward from a lower edge of the fixture head, and wherein the keying tab is received by a groove formed in an upper edge of the fixture base when the fixture is in the connected use position.

12. The outdoor repellant system of claim 4, wherein the volatilizing unit comprises a bracket, a heater residing within a cavity of the bracket, and a reservoir coupler extending downward from the bracket, and
wherein when the fixture is in the connected use position, an upper extent of the repellant reservoir is received by the reservoir coupler to join the repellant reservoir to the bracket.

13. The outdoor repellant system of claim 12, the repellant reservoir including a wick with an upper portion that extends upward through an upper opening in the repellant reservoir, wherein the upper portion of the wick extends (i) through an aperture in the bracket and (ii) into an aperture in the heater for volatilization of repellant from the reservoir.

14. The outdoor repellant system of claim 13, wherein the bracket further includes at least one guide rib disposed along an inner wall defining the bracket aperture;
wherein in the connected use position, the guide rib engages and centrally locates the upper portion of the wick within both the bracket aperture and the heater aperture such that the upper wick portion does not contact the heater.

15. The outdoor repellant system of claim 12, wherein the reservoir coupler includes at least one retention tab that is configured to removably and securely receive the upper extent of the reservoir in the connected use position.

16. The outdoor repellant system of claim 15, wherein the retention tab includes an internal ridge that engages an external thread of the upper extent of the reservoir in the connected use position.

17. The outdoor repellant system of claim 12, wherein the bracket includes a depending flange that resides within the reservoir coupler in the connected use position.

18. The outdoor repellant system of claim 12, wherein the volatilizing unit further comprises a compressible resilient member that exerts an upwardly directed force on a lower portion of the repellant reservoir in the connected use position.

19. The outdoor repellant system of claim 18, wherein the compressible resilient member is a thin pad that elastically deforms when engaged with the repellant reservoir in the connected use position.

20. An outdoor repellant system for providing an insect controlled region at an installation site, the outdoor repellant system comprising:
at least one repellant device that includes a fixture, a support member and a stake configured to be inserted into a support surface at the installation site, wherein each fixture comprises:
a fixture head with at least one outlet opening through which a volatized repellant is discharged, the fixture head having at least one internal latch receptacle;
a fixture base with at least one inlet opening through which inlet air is drawn, the fixture base having at least one internal latch that mates with the latch receptacle of the fixture head to releasably secure the fixture base to the fixture head in a connected use position; and,
a repellant reservoir removably secured within the fixture by a volatilizing unit that provides for volatilization of repellant supplied from the reservoir.

21. The outdoor repellant system of claim 20, wherein the support member is coupled to a lower portion of the fixture and the support member is further coupled to the stake in the connected use position for each repellant device,
wherein in the connected use position, the fixture are elevated by the support member above the support surface to provide the insect controlled region at the installation site.

22. The outdoor repellant system of claim 20, the repellant device further including a device wire that extends through the fixture, the support member and the stake,
wherein the device wire is electrically connected to a primary power source for operation of the repellant device in the connected use position.

23. The outdoor repellant system of claim 22, the repellant device further including a connector that is electrically coupled to the device wire, the connector including a wire adapter.

24. The outdoor repellant system of claim 23, further comprising a main power line electrically connected to the primary power source and routed within or along the support surface at the installation site,
wherein the main power line extends through both the wire adaptor and the connector to electrically connect with the device wire to provide power to the repellant device.

25. The outdoor repellant system of claim 20, wherein the fixture includes a release mechanism operably connected to the internal latch of the fixture base;
wherein an operator actuates the release mechanism to disengage the internal latch from the latch receptacle of the fixture head in order to detach the fixture head from the fixture base and displace the fixture head from the connected use position to a disconnected position.

26. The outdoor repellant system of claim 25, wherein the release mechanism comprises a depressible button and a biasing member, the depressible button being accessible through an opening formed in the fixture base.

27. The outdoor repellant system of claim 26, wherein the operator applies an inwardly directed disconnection force to the depressible button in order to disengage the internal latch from the latch receptacle and move the fixture from the connected use position to the disconnected position.

28. The outdoor repellant system of claim 20, wherein the internal latch resides within a latch housing that extends upward from the fixture base into the fixture head when the fixture is in the connected use position.

29. The outdoor repellant system of claim 28, wherein the internal latch includes a projection that engages with a securing element formed in the latch receptacle when the fixture is in the connected use position.

30. The outdoor repellant system of claim 20, wherein the latch receptacle extends from a lower edge of the fixture head towards a top wall of the fixture head.

31. The outdoor repellant system of claim 20, wherein the fixture head includes at least one keying tab extending downward from a lower edge of the fixture head, and wherein the keying tab is received by a groove formed in an upper edge of the fixture base when the fixture is in the connected use position.

32. The outdoor repellant system of claim 20, wherein the volatilizing unit comprises a bracket, a heater residing within a cavity of the bracket, and a reservoir coupler extending downward from the bracket, and
wherein when the fixture is in the connected use position, an upper extent of the repellant reservoir is received by the reservoir coupler to join the repellant reservoir to the bracket.

33. The outdoor repellant system of claim 32, the repellant reservoir including a wick with an upper portion that extends upward through an upper opening in the repellant reservoir, wherein the upper portion of the wick extends (i) through an aperture in the bracket and (ii) into an aperture in the heater for volatilization of repellant from the reservoir.

34. The outdoor repellant system of claim 32, wherein the bracket further includes at least one guide rib disposed along an inner wall defining the bracket aperture;
wherein in the connected use position, the guide rib engages and centrally locates the upper portion of the wick within both the aperture and the heater aperture such that the upper wick portion does not contact the heater.

35. The outdoor repellant system of claim 32, wherein the reservoir coupler includes at least one retention tab that is configured to removably and securely receive the upper extent of the reservoir in the connected use position.

36. The outdoor repellant system of claim 35, wherein the retention tab includes an internal ridge that engages an external thread of the upper extent of the reservoir in the connected use position.

37. The outdoor repellant system of claim 32, wherein the bracket includes a depending flange that resides within the reservoir coupler in the connected use position.

38. The outdoor repellant system of claim 32, wherein the volatilizing unit further comprises a compressible resilient member that exerts an upwardly directed force on a lower portion of the repellant reservoir in the connected use position.

39. The outdoor repellant system of claim 38, wherein the compressible resilient member is a thin pad that elastically deforms when engaged with the repellant reservoir in the connected use position.
